(19) United States
(12) Patent Application Publication
(10) Pub. No.: US 2005/0071350 A1
(43) Pub. Date: Mar. 31, 2005

(54) Systems and methods for information technology resource management

(75) Inventors: Frank G. Artale, Woodinville, WA (US); Murthy Srinivas, Redmond, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 10/927,920

(22) Filed: Aug. 28, 2004

Related U.S. Application Data
(60) Provisional application No. 60/499,302, filed on Aug. 28, 2003.

(51) Int. Cl. G06F 17/00

(52) U.S. Cl. 707/100

(57) ABSTRACT

Systems and methods for managing information technology (IT) resources can include at least one resource definition. The resource definition specifies a location and identity of a corresponding resource, and methods that can be performed on the resource. An instance of the resource that includes information from the at least one resource definition is stored. A package is generated based on at least one execution unit (EU), workflow associated with the EU, and the resource definition, wherein the package causes the resource to perform at least one of the methods.

### BACKGROUND

The rapid pace of computer technology development has spawned a diverse array of hardware and software environments, placing limitations on the ability of information technology (IT) departments to respond to change. Businesses/corporations are increasingly leveraging computing to differentiate themselves from the competition, which in turn requires that IT departments to respond rapidly to requests for new, or changes to existing, information systems. Further, the inability to accurately forecast computing needs often results in a constant stream of migration and deployment methods. These are issues that IT departments must contend with over and above the ongoing methods of running and maintaining the systems and network.

IT departments initially increased staff to keep up with growth, but have realized that hiring alone cannot solve the problems. In particular, IT departments must deal with the problem of finding people with the right expertise, as well as problems associated with ill-defined practices and undocumented procedures used to train them. IT departments must often contend with losing a substantial portion of this accumulated knowledge due to personnel turnover. In addition, many of the current IT management processes are manual as opposed to being automated, which requires long lead times to implement changes.

The downward trend in hardware costs over the years has encouraged IT departments to scale out rather than scale up. Scale-up architecture involves migrating to larger, faster systems to gain more computing power. Scale-out architectures distribute the workload over many different servers, so each individual server need only be powerful enough to handle the load of a smaller percentage of the overall systems. System management tools are only capable of monitoring individual systems and network elements, resulting in a different class of management problems that need to be addressed for a collection of diverse resources.

### SUMMARY

Systems and methods for managing information technology (IT) resources can include at least one resource definition. The resource definition specifies a location and identity of a corresponding resource, and methods that can be performed on the resource. An instance of the resource that includes information from the at least one resource definition is stored. A package is generated based on at least one execution unit (EU), workflow associated with the EU, and the resource definition, wherein the package causes the resource to perform at least one of the methods.

### BRIEF DESCRIPTION OF THE DRAWINGS

Embodiments of the present invention may be better understood, and their numerous objects, features, and advantages made apparent to those skilled in the art by referencing the accompanying drawings. The use of the same reference symbols in different drawings indicates similar or identical items.

FIG. 1 is a diagram of a network in which a resource lifecycle management system in accordance with embodiments disclosed here may be utilized;

FIG. 2A is a diagram of an embodiment of a resource lifecycle management system;

FIG. 2B is a diagram of an inheritance hierarchy for a resource that can be managed using the resource lifecycle management system of FIG. 2A;

FIG. 2C is a diagram of a containment hierarchy for a an element of the resource represented in FIG. 2B;

FIG. 3 is a diagram of an embodiment of relationships between functional, dialog, and presentation layers of a resource lifecycle management system;

FIG. 4 is a diagram of an embodiment of a graphical user interface the presentation layer of a resource lifecycle management system;

FIG. 5 is a diagram of files derived from an Extensible Markup Language (XML) document representing a package in the resource lifecycle management system of FIG. 2A;

FIG. 6 is a diagram showing a hierarchy of agents that can be used to implement components of the graphical user interface of FIG. 4; and

FIGS. 7A and 7B (collectively FIG. 7) show a diagram of components included in an implementation of the graphical user interface of FIG. 4.

### DETAILED DESCRIPTION

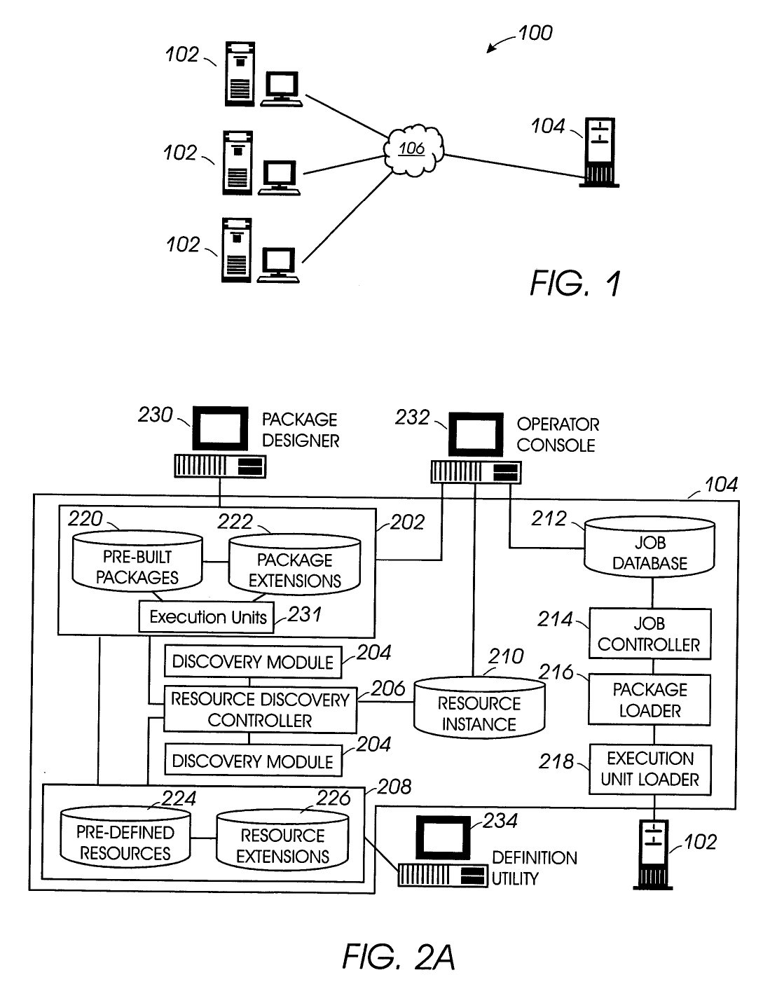

FIG. 1 shows a diagram of a distributed processing system 100 including one or more processing units, also referred to as nodes 102, configured to communicate with one or more resource management server(s) 104 via network 106. Nodes 102 can access various local resources, and shared resources over network 106. Access and priority to various resources can be determined, for example, by a network administrator. As further discussed herein, management server 104 facilitates configuration and management of diverse resources by discovering and identifying the available resources and providing facilities to deploy and monitor the resources in a consistent manner regardless of the resource types.

As used herein, the term “resource” refers to software and hardware components that are accessible locally and/or over a network. The resources can include both elemental resources such as servers, switches, file services, disk drives, printers, application programs, and the like, as well as aggregate resources such as web farms and other resources comprising a plurality of more basic components. Resource management can include methods such as locating, identifying, and characterizing existing resources; identifying the dependencies between the various resources; adding new resources, modifying the attributes of existing resources; re-asking or repositioning existing resources; and removing resources. A resource can have attributes and be associated with operational methods. For example, a disk can be formatted, partitioned, and/or appended to an existing drive. A file service can be moved, split, or merged with other file services.

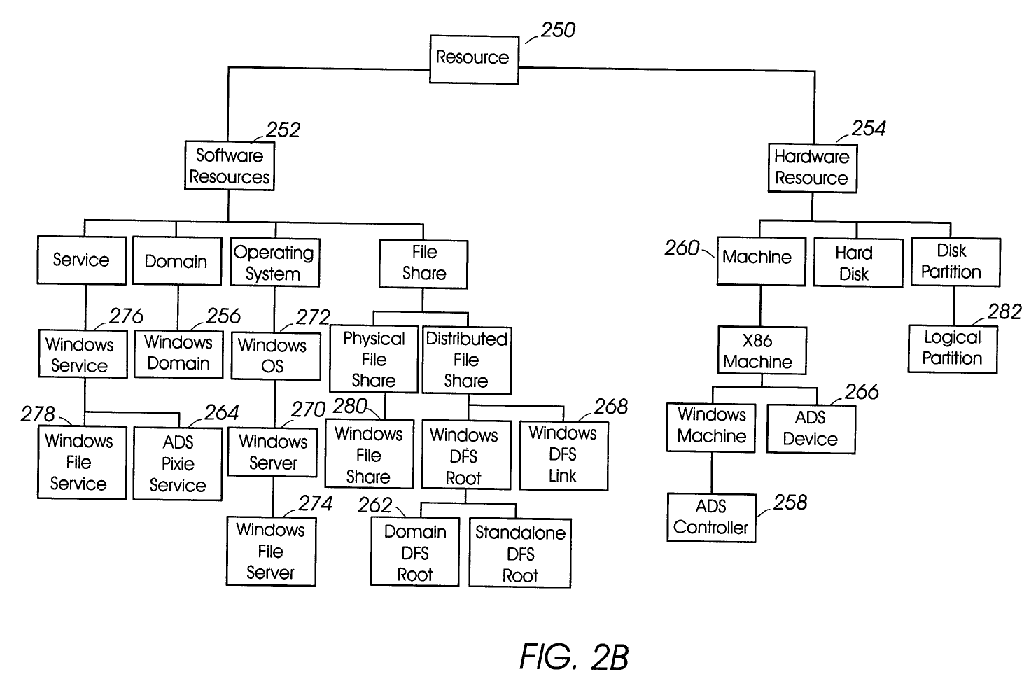

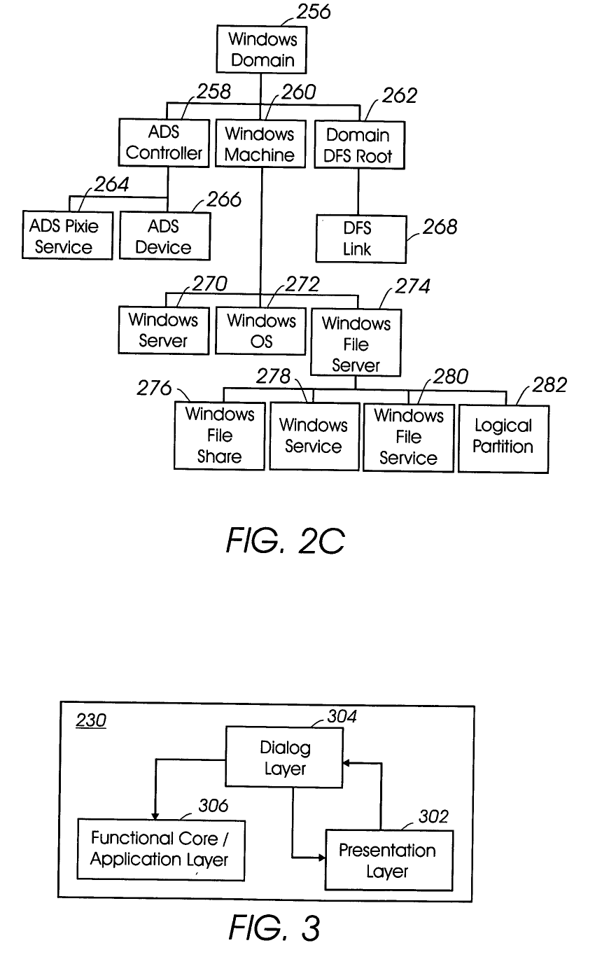

Referring to FIG. 2A, an embodiment of management server 104 is shown including package repository 202, discovery modules 204, resource discovery controller 206, resource definitions 208, resource instances 210, job database 212, job controller 214, package loader 216, and execution unit loader 218. Packages 220, 222 can be registered in repository 202 and associated with an operational method of a resource. Repository 202 can include pre-built packages 220 that can be used as-is or customized. Additional packages and extensions of existing packages 222 can be created via package designer 230. Resource definitions 208 can include pre-defined resource definitions 224 and resource definition extensions 226. Package designer 230, operator console 232, resource definition utility 234, and node 102 are coupled to communicate with various components in management server 104.

Package designer 230 is coupled to communicate with package repository 202 and can use resource definitions 208 to provide a higher level, abstract view of resources. Packages 220, 222 can include one or more execution units (EUs) 231. EUs 231 can encapsulate logic to execute a specific method. An operator can invoke a package 220, 222 via a user interface (UI), a command line interface (CLI) on operator console 232, or other suitable means. In some instances, the user can provide input to package 220, 222. Invoking package 220, 222 can cause a job to be created that is deposited in job database 212. Job controller 214 can extract jobs from job database 212 and provide the jobs to package loader 216. The jobs can be executed by an appropriate EU loader 218 and the results can be returned and displayed to the job initiator.

EUs 231 can be configured to execute a specific method, and typically do not invoke other EUs 231. EUs 231 can be configured as wrappers for capabilities that are implemented elsewhere, such as in deployment packages for a software or hardware resource. In addition to the logic for executing the method, EUs 231 can include logic to rollback (undo) previously performed operations in the event of a failure. EUs 231 can be used in other packages 220, 222 where the same functionality is desired. EUs 231 can include features such as execution logic; a document that provides information regarding the origin, purpose, and authenticity of EU 231; information for locating and loading EU 231; and parameters that must be set before EU 231 can be executed. The parameters can be initialized using any suitable method, such as retrieving resource properties/attributes from resource instance database 210, supplied interactively via operator console 232, and/or using default values, among others. EUs 231 can be stored in repository 202.

Resource definition utility 234 can be used to define resource types that can be managed via management server 104. Resource types can be represented by properties and/or attributes relevant to management server 104. Properties and attributes can also include logic to obtain a corresponding value for the property or attribute once a resource and its type are identified. Further, resources can be associated with methods that allow an IT administrator to perform any available management method for the resource. For example, for a printer, methods may be available that allow the administrator to move the printer from one node 102 to another node 102, rename the printer, and share the printer with other nodes 102. The methods associated with a resource can be deployed with the resource, or made available by other suitable means.

Resource definitions 208 can include pre-defined resource definitions database 224. New resource definitions may be created and existing defined resources may be extended via definition utility 234 and deposited in resource definition extensions database 226. The resource definition extensions 226 can be configured to be usable across product upgrades. In some embodiments, resource definitions 208 can be Extensible Markup Language (XML) schemas, however other suitable formats can be utilized. The attributes and properties of a resource can be addressed individually through a classification scheme and the values can be accessible from resource instance database 210. The properties and attributes can be used to create a job that executes appropriate logic to provide consistent management features for various types of resources.

Resource discovery controller 206 can be configured to access resource definitions 208 to find resources of interest using a discover method that can be specified in resource definitions 208. A resource type can participate in an inheritance hierarchy and a containment hierarchy. Accordingly, a resource type can include one or more resource types that in turn can include one or more resource types, and so on.

In some embodiments, discovery is conducted in a hierarchical fashion, as indicated by the hierarchy shown FIG. 2B for an aggregate resource 250 that includes both software resources 252 and hardware resources 254. For example, the resource definition 208 for resource 250 can be discovered, which can include properties and attributes for the resource 250. For each discovered instance of a top-level resource, a containment hierarchy can be traversed and resources probed and discovered. Containment hierarchy allows aggregate resources to be defined and recognized as separate entity types. Such relationships can be static or dynamic in nature and established during resource discovery.

FIG. 2C shows an example of a containment hierarchy for Windows Domain resource 256, which is one of the software resources 252. In the example shown, Windows Domain resource 256 contains, or depends on, Automated Deployment Services (ADS) Controller 258, Windows Machine 260, and Domain DFS Root 262. ADS Controller 258 contains ADS Pixie Service 264, and ADS Device 266. Domain DFS Root 262 contains DFS Link 268. Windows Machine 260 contains Windows Server 270, Windows Operating System 272, and Windows File Server 274. Windows File Server 274 contains Windows File Share 276, Windows Service 278, Windows File Service 280, and Logical Partition 282.

Resource discovery controller 206 can utilize containment hierarchy definitions to facilitate identification and characterization of instantiations of aggregate resources. For example, the containment hierarchy for resources 256-282 in FIG. 2C can be developed by resource discovery controller 206 based on the probe of the inheritance hierarchy for resource 250 shown in FIG. 2B. Additionally, the containment hierarchy can be leveraged by a package 220, 222 to perform operations on an aggregated resource without being explicitly aware of the mechanics of how operations are performed on the contained resources.

Resource discovery controller 206 can also utilize discovery modules 204 to extract information from existing asset/inventory databases and/or interface to monitoring products that can provide such information. Discovery modules 204 can be implemented as a plug-in to discovery controller 206. The scope and frequency of discovery for various types of resources can be configured via operator console 232 or other suitable method. The jobs can be scheduled to execute during weekends or off-peak hours, executed in parallel to minimize downtime, asynchronously/synchronously etc. The jobs can also be tracked, suspended or cancelled. In the event of errors, the job execution can be halted and EUs 231 informed so that affected resources can be returned to their original state prior to the start of the job. The discovery process can be initiated/repeated as often as needed based on the requirements of the organization.

Discovery modules 204 can access resource definitions 208 and update resource instance database 210. If the information is being extracted from an existing source such as an asset/inventory database, discovery modules 204 can map and transform the information formats suitable for resource instance database 210. Resource instance database 210 can also be updated manually through a resource instance database update tool (not shown) via operator console 232.

Resource instance database 210 can maintain the identified resource instances, and the properties and attributes associated with the instances along with any relationships discovered. The information in resource instance database 210 can be accessed through queries. The contents of resource instance database 210 can vary depending on the resource types of interest, methods of discovery, and scope of discovery.

Operator console 232 can display symbols representing packages 220, 222 and resources available for selection. Once an operator selects a package 220, 222 and the resource(s) from the operator's console 232, a job can be inserted into job database 212 for dispatching and tracking. The job can be scheduled to run immediately or at a later time. Job database 212 can monitor the state and schedule of jobs to assist job controller 214 in dispatching jobs. Job database 212 can be queried as to the progress of a job and also used to suspend or cancel a job in progress.

Job controller 214 can dispatch and control execution of jobs. Job controller 214 can launch a package loader 216 to execute the package 220, 222 associated with a job. The package loader 216 can facilitate linking input parameters to the executing package 220, 222 along with providing interfaces to job related services such as logging and rollback. The executing package 220, 222 is typically in binary object code format. Additionally, a package 220, 222 can request job controller 214 to execute another of packages 220, 222.

Package loader 216 can dispatch EUs 231 to an appropriate EU loader 218 for execution. The results from the execution of EU 231 can be stored by job controller 214 to facilitate linkage for subsequent EUs 231, as required. Additionally, EU loader 218 can provide an interface to EU 231 to save state information.

If an EU 231 fails, the job execution can be halted and package loader 216 can invoke the executed EUs 231 in reverse order to undo the effects of their previous execution using the stored state information, if necessary. After successful package execution, package loader 216 can invoke an executed EUs' cleanup method and use the save state information for any cleanup that might be required. Job controller 214 can be configured to capture status in job database 212 or other suitable location after EU execution, along with results and output from EU 231. EU loader 218 and package loader 216 can also provide appropriate interfaces to the packages 220, 222 and EUs 231 to store trace/debug output.

EUs 231 and package loader 216 can be configured to run on management server 104 and/or nodes 102.

Roles can be defined for users of management server 104. For example, anyone who wishes to access components of management server 104 may be required to be registered as a user. User authentication can be implemented to require a login name and/or password, or other suitable access control features.

Users authorized to act as administrators can be placed on a list that identifies the users as administrators. Additional users can be explicitly tagged to play an administrative role. Administrators can be given access to fill any role and use any feature of management server 104.

A resource administrator role can be implemented to identify users who are authorized to define new resources or modify existing resources in resource definitions 208, configure the frequency and scope of resource discovery, associate packages 220, 222 with operation methods of a resource, and other suitable functions.

A resource discoverer role can be implemented to identify users who are authorized to explicitly initiate resource discovery.

A process automation EU designer role can be implemented to identify users who are authorized to design new EUs 231 and deposit the EUs 231 in repository 202.

A process automation package designer role can be implemented to identify users who are authorized to design new packages 220, 222 using the available EUs 231 and depositing packages 220, 222 in repository 202 for job creation.

A process automation tester role can be implemented to identify users who are authorized to validate packages 220, 222, job creation, and job execution.

A process automation package approver role can be implemented to identify users who are authorized to approve a package 220, 222 for general availability once it has been tested. Note that only approved packages 220, 222 will show up in the list of operational methods for a resource.

A process automation job creator role can be implemented to identify users who are authorized to create jobs using the approved packages 220, 222 and make them available in job database 212.

A process automation job dispatcher role can be implemented to identify users who are authorized to dispatch jobs available in job database 212 and track the jobs to completion. Other suitable roles can be implemented in addition to, or instead of, the aforementioned roles.

Management server 104 can be configured to conform to the security requirements defined by the operating environment by participating in the appropriate security domain hierarchy. Appropriate impersonation and delegation capabilities can be enabled to ensure that cross-machine operations on nodes 102 perform as expected.

Operations performed by management server 104, such as package creation, package approval, job creation, job submission, and role changes, among others, can be logged for auditing and tracking. The logged information can be stored in any suitable location and can be configured to require appropriate authorization to access.

Table I shows an embodiment of elements and corresponding attributes that can be included in an XML schema for a resource definition 208. Resource definitions 208 can specify one or more method, property, structure, dependency, and/or enumeration elements. One or more attributes can be associated with the elements. Attributes can be specified for the resource to allow components in management server 104 to locate and handle the resource.

TABLE I
Sample XML Schema for Resource Definition

| Element | Attributes | Comments |
|---|---|---|
| RESOURCE | Namespace | Resource attributes |
| | NamespaceSchemaLocation | can be used to |
| | Name | indicate |
| | ParentId | characteristics such |
| | IsAbstract | as location, name, |
| | ResourceTTL | hierarchy (parent), |
| | NotDiscoveredTTL | abstraction, time to |
| | IsDiscoverable | live (TTL), whether |
| | IsImmutable | the resource is |
| | IsInternal | discoverable, whether |
| | Namespace | the resource |
| | SolutionId | definition can be |
| | Id | modified, and other |
| | | identifying |
| | | information for the |
| | | resource. |
| ABSTRACT | Author | Author and version |
| | MajorVersion | information for the |
| | MinorVersion | resource. |
| METHODS | | The Discover Method |
| DISCOVER | Supplemental | can be invoked to |
| EXECINFO | Assembly | find resources. |
| | Class | Method elements and |
| | EntryMethod | attributes can be used |
| METHOD | Name | to indicate |
| | ReturnType | characteristics of |
| EXECINFO | Assembly | each method |
| | Class | specified for the |
| | EntryMethod | resource, such as |
| PARAMETER | Name | method name, |
| | ReturnType | parameter return |
| PARAMETER | RemoteName | type(s), programming |
| | Type | language, and class. |
| | LocalName | Additional |
| | IsLocalProperty | parameters can be |
| | IsCollection | used to provide |
| | | information regarding |
| | | the location of remote |
| | | methods, and whether |
| | | the method is part of |
| | | a collection of other |
| | | methods. |
| PROPERTIES | | |
| PROPERTY | Name | Attributes for |
| | Type | property elements can |
| | DefaultValue | be used to provide |
| | IsCollection | information regarding |
| | IsRequired | the resource |
| | IsKey | definition, such as the |
| | IsUnique | name, type (e.g. |
| | IsExpensive | Structure or |
| | IsInTemplate | Enumeration type). |
| | | The parameters can also |
| | | be used to specify a |
| | | default value for the |
| | | property, whether the |
| | | property is a collection of |
| | | elements of the given |
| | | type, whether the |
| | | property must be |
| | | specified on an instance |
| | | of the RESOURCE |
| | | (IsRequired), whether |
| | | this is a property that is |
| | | used to identify the |
| | | RESOURCE (IsKey), |
| | | whether this property |
| | | must have a unique value |
| | | for each RESOURCE |
| | | instance (IsUnique), and |
| | | whether the RESOURE |
| | | is expensive in terms of |
| | | system resources used. |
| STRUCTURES | | Can be used to define |
| STRUCTURE | Name | PROPERTY types. |
| FIELD | Name | |
| | Type | |
| | DefaultValue | |
| | IsCollection | |
| | IsRequired | |
| DEPENDEN- | | Attributes for |
| CIES | | dependency elements |
| DEPENDENCY | Name | can be used to |
| | Type | provide information |
| | IsCollection | regarding the |
| | IsRequired | hierarchical position |
| | | of a resource that is |
| | | part of a collection of |
| | | other resources. |
| ENUMERA- | | Attributes for |
| TIONS | | enumeration elements |
| ENUMERATION | Name | can be used to set |
| ENTRY | Name | default constant |
| | Value | values of attributes |
| | | for other elements. |

A PROPERTY element defined as a resource type implicitly defines a containment relationship between the type being defined and the contained type being defined as a property, and is used by the discovery controller 206 to automatically create relationships in the instance database based on this containment relationship. Resource definitions 208 can be generated manually, with the aid of a graphical user interface, and/or any other suitable method. Note that other elements and attributes can be included in resource definitions 208, in addition to, or instead of, the elements and attributes shown in Table I.

An example of a resource definition 208 that follows the XML schema format outlined in Table I for a Automated Deployment Services (ADS) Controller is shown below:

```
<RESOURCE xmlns:xsi=“http://www.w3.org/2001/XMLSchema-instance”
    xsi:noNamespaceSchemaLocation=“..\OMBase\ResourceSchema.xsd”
    Name=“ADSController”
    ParentId=“Resource.HardwareResource.Machine.X86Machine.WindowsMachine”
    IsAbstract=“false” ResourceTTL=“0” NotDiscoveredTTL=“0”
    IsDiscoverable=“true” IsImmutable=“false” IsInternal=“false”
    Namespace=“HPSD.RM.OM” SolutionId=“CA8DE728-7BCB-4029-ADF0-
    5700F982C024” Id=“088842DD-953E-49F6-B358-4BECFB753BFC”>
<ABSTRACT MajorVersion=“2” MinorVersion=“0” Author=“peeyush@hp.com” />
<METHODS>
  <DISCOVER Supplemental=“true”>
    <EXECINFO
    Assembly=“%HPSD_BINS_DIR%\HPSD.RM.DiscoveryModules.dll”
    Class=“ADSControllerDisco” />
  </DISCOVER>
  <METHOD Name=“RunSequence” ReturnType=“System.Guid”
    SolutionId=“CA8DE728-7BCB-4029-ADF0-5700F982C024”
    ResourceId=“088842DD-953E-49F6-B358-4BECFB753BFC”
    MethodId=“891D87E4-ECCA-435C-BB5E-7CE91352E365”>
  <EXECINFO Class=“HPSD.Solutions.Package.ADS.RunSequence”
    EntryMethod=“Execute” />
    <PARAMETER IsLocalProperty=“true” RemoteName=“ADSControllerName”
    Type=“System.String” LocalName=“NetworkID” />
    </METHOD>
    </METHODS>
<PROPERTIES>
  <PROPERTY Name=“PixieService”
    Type=“Resource.SoftwareResource.Service.WindowsService.ADSPixieService”
    IsRequired=“false” />
  <PROPERTY Name=“Devices”
    Type=“Resource.HardwareResource.Machine.X86Machine.ADSDevice”
    IsRequired=“true” IsCollection=“true” />
  <PROPERTY Name=“Images” Type=“Image” IsRequired=“true”
    IsCollection=“true” />
  </PROPERTIES>
<STRUCTURES>
  <STRUCTURE Name=“Image”>
    <FIELD Name=“Name” Type=“System.String” />
    <FIELD Name=“CreationTime” Type=“System.String” />
    <FIELD Name=“Description” Type=“System.String” />
    <FIELD Name=“PartitionNum” Type=“System.String” />
    <FIELD Name=“PartitionLength” Type=“System.Int64” />
    <FIELD Name=“OSMajor” Type=“System.Int32” />
    <FIELD Name=“OSMinor” Type=“System.Int32” />
    <FIELD Name=“Variables” Type=“ImageVariable” IsCollection=“true” />
    </STRUCTURE>
  <STRUCTURE Name=“ImageVariable”>
    <FIELD Name=“Name” Type=“System.String” />
    <FIELD Name=“IsPasswordField” Type=“System.Boolean” />
    </STRUCTURE>
    </STRUCTURES>
  <DEPENDENCIES />
  <ENUMERATIONS />
  </RESOURCE>
```

In the example above, the METHODS, PROPERTIES, and STRUCTURES elements include more than one respective METHOD, PROPERTY, and STRUCTURE sub-elements. Note that other elements, such as DEPENDENCIES and ENUMERATIONS can also include a sequence of more than one corresponding sub-element.

Referring to FIG. 3, in some embodiments, package designer 230 provides a user interface that assists the user in visually modeling a package 220, 222, and a backend that provides access to the various abstractions, ensures consistency in workflow and with resource definitions 208 (FIG. 2A), and emits code that can be used for executing the designed process. Package designer 230 can be separated into three functional layers: a presentation layer 302; dialog layer 304; and functional core/application layer 306.

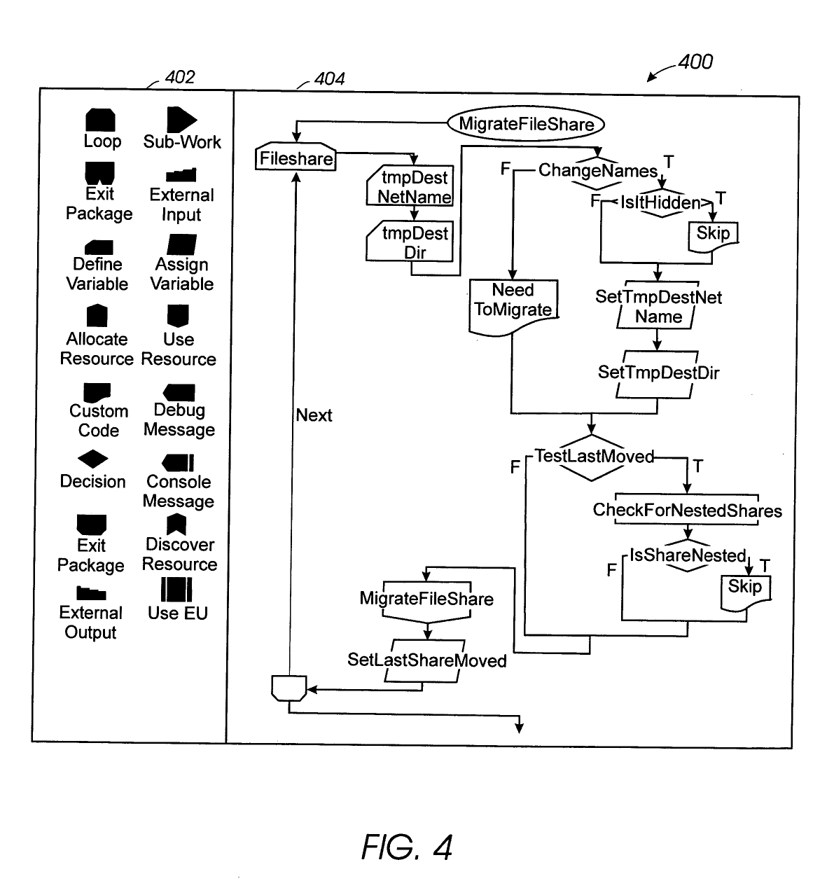

Presentation layer 302 can include a front end, stencils/shapes and their associated behaviors, and an extensibility mechanism that allows interfacing with dialog layer 304. Referring to FIGS. 3 and 4, to build a package 220, 222, presentation layer 302 can provide a graphical user interface (GUI) 400 that allows the user to select operations to include in the package 220, 222, set variables, provide conditions to specify the workflow between selected EUs 231, provide expressions to be evaluated, identify the subsequent paths to be taken, and provide linkage information between the EUs 231 for passing information between EUs 231 in the flow.

The example of GUI 400 shown in FIG. 4 includes a first window 402 with a group of symbols that represent different types of computer programming logic structures or operations. In the embodiment shown, window 402 includes symbols representing an iterative loop, sub-routine, Exit Package, External Input, Define Variable, Assign Variable, Allocate Resource, Use Resource, Custom Code, Debug Message, Decision, Console Message, Exit Package, Discover Resource, External Output, and Use EU. Copies of the symbols in window 402 can be individually dragged and dropped to second window 404 of GUI 400, and a corresponding name of a variable, method, resource, EU, or other component can be provided by the user as a label for the symbol. For example, window 404 shows a flow diagram for a package 220, 222 that can be invoked to migrate a file share resource from one location to another. Three Assign Variable symbols labeled with variable names SetTmpDestNetName, SetTmpDestDir, and SetLastShareMoved are included in the flow diagram. A Use EU symbol labeled CheckForNestedShares is also included, along with various Decision, Custom Code, Define Variable, and Loop symbols. The user can draw lines between the symbols to indicate the flow of operations in package 220, 222.

When a new package 220, 222 is written for a resource operation that requires user input when invoked, the interface for such input needs to be developed as well. GUI 400 can be implemented with logic instructions that examine the packages 220, 222 and EUs 231 to identify entry points. For each of the entry points, the logic can determine the domain to which the input data belongs and present the user with the option to enter data from that domain. Additionally, different parts of user inputs can be tied together to further narrow the domain that is valid for other inputs.

For each input, package designer 230 can indicate whether the input is constant, user-provided, or available from resource instance database 210. For the first two, the layout format can take into consideration the type information for lengths and appropriate edit masks. If the input is available from resource instance database 210, a listbox can be created and populated with selectable instances of the particular resource type.

GUI 400 can include features such as horizontal and/or vertical scroll bars; drop-down menus; commands such as move, copy, paste, cut, save, print, and resize; and features that allow windows 402 and 404 to be resized. Other suitable features, such as features commonly provided with application software for the WINDOWS® Operating System by Microsoft Corporation, Redmond, Wash., can also be implemented, as desired. Further, other symbols representing other functions can be included in window 402 in addition to, or instead of, the symbols shown in FIG. 4.

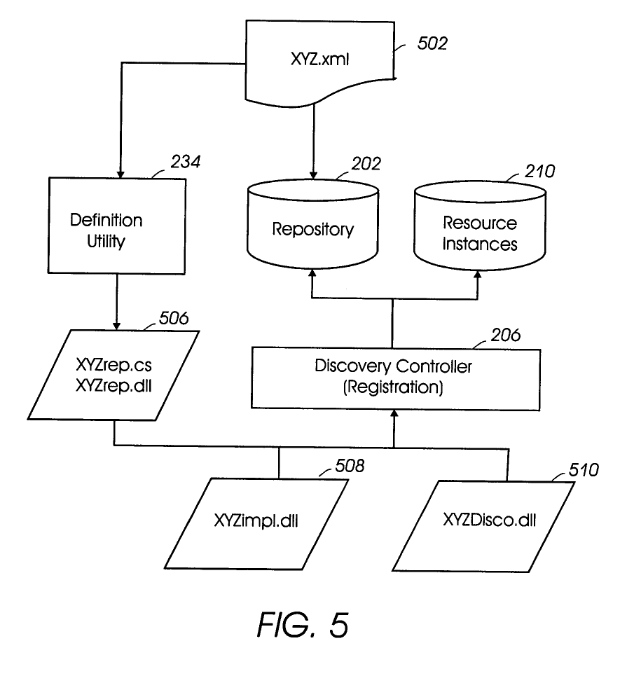

Functional core layer 306 can encapsulate the flow of package 220, 222 in a collection of in-memory objects that can be manipulated, as well as loaded and saved to disk. By tying the objects together, an execution flow can be created that can be stored as source code, such as C# source code, compiled, and executed. Referring to FIGS. 2 and 5, FIG. 5 shows a diagram of an embodiment of relationships between an XML schema for a resource definition 208 and components in management server 104, as rendered by functional core layer 306. A user supplies an XML schema document 502 to definition utility 234. In some embodiments, definition utility 234 can include a user interface that allows the user to create XML schema document 502. Definition utility 234 can convert the XML schema document 502 to a C# source code file, compile the source, and output the object code in a dynamic linked library (dll) file, as indicated by blocks 506, 508, and 510. Discovery controller 206 can register the source file and dll file in repository 202 and resource instances database 210. The XML schema document 502 can also be provided to repository 202. In the example shown, XYZimpl.dll is the file that includes the executable methods on the RESOURCE objects, while the XMLDisco.dll file contains the executable discovery method. Note that the discovery method is typically a static method that creates entries in resource instance database 210 for the resources it discovers.

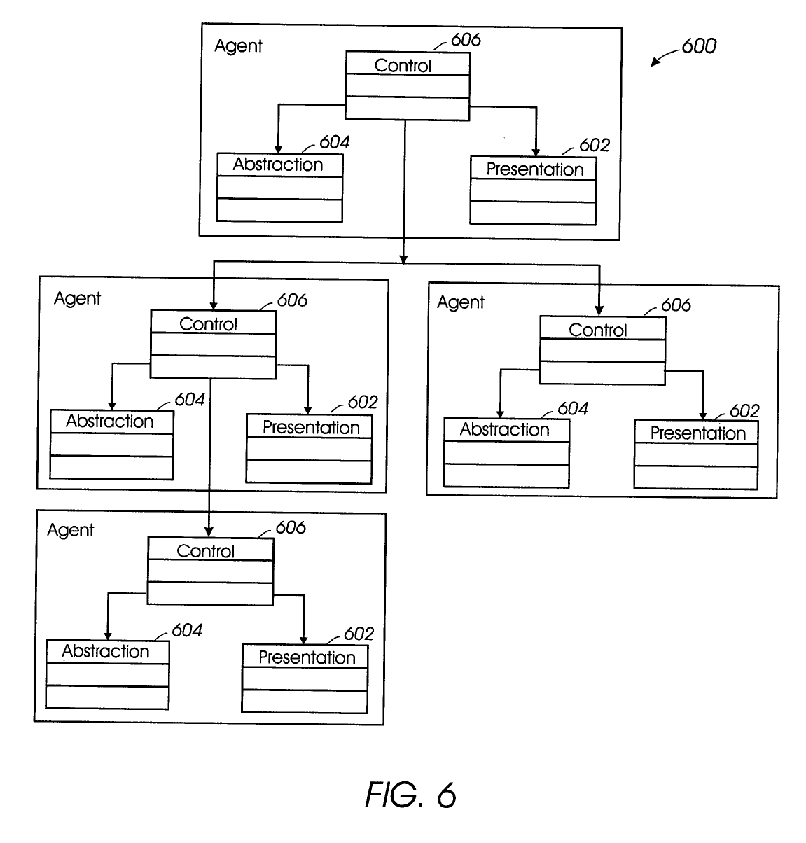

Referring to FIGS. 3 and 6, dialog layer 304 can be configured to manage the interaction between presentation layer 302 and functional core layer 306 by handling user input and taking appropriate action to handle the input. Dialog layer 304 can be structured using a Presentation Abstraction Control (PAC) pattern. PAC defines a structure for interactive software systems in the form of a hierarchy of cooperating agents 600. Every agent can be responsible for a specific aspect of the functionality of package designer 230, and can include three components for each aspect: presentation component 602, abstraction component 604, and control component 606. Such a subdivision separates presentation layer 302 from functional core layer 306.

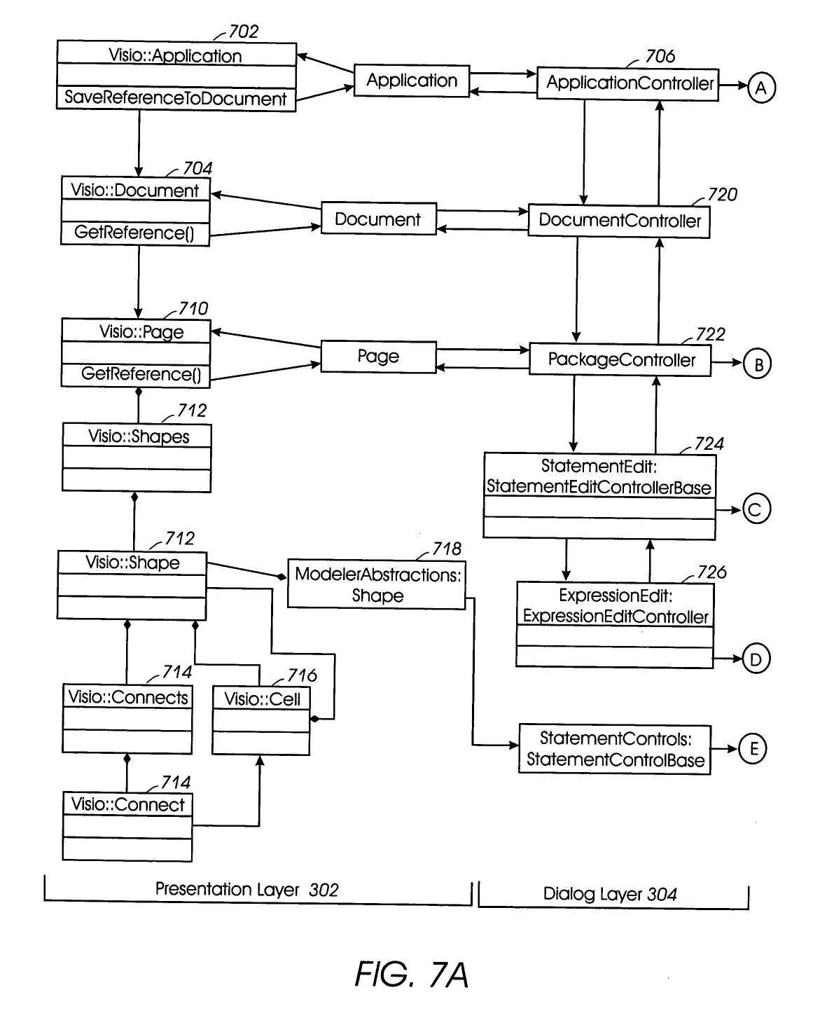

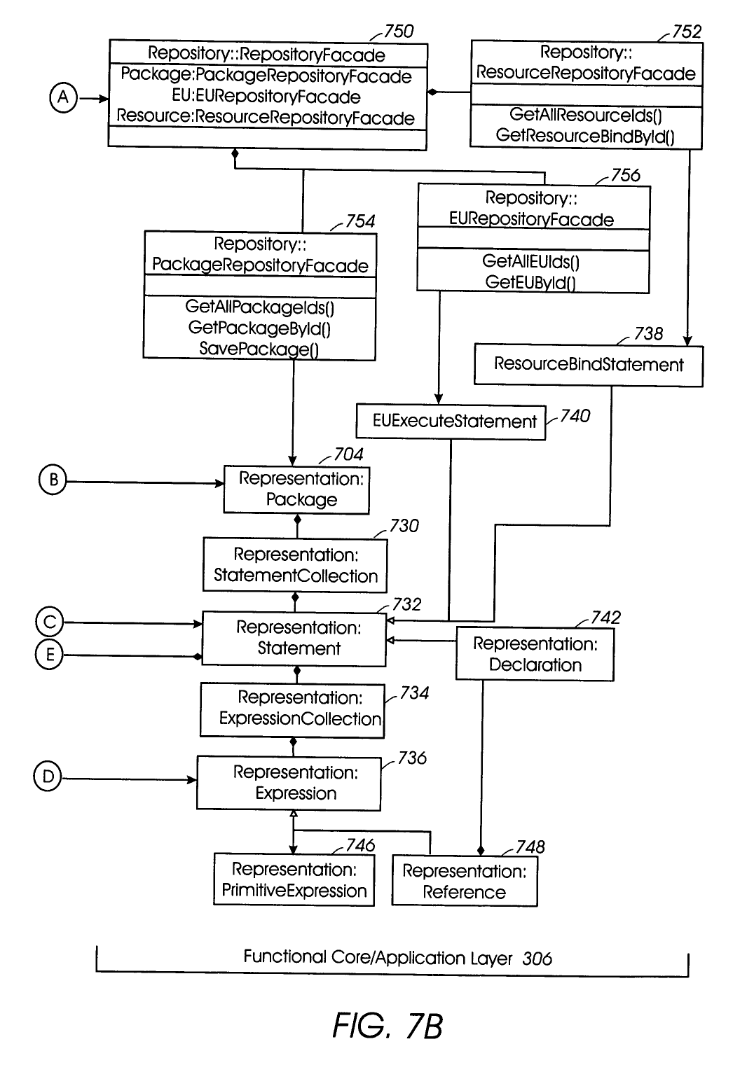

Referring to FIGS. 7A and 7B, collectively FIG. 7, in some embodiments, package designer 230 can use a graphics application program 702 to implement portions of GUI 400 (FIG. 4). Packages 220, 222 can be represented by a corresponding document 704. One suitable graphics program for such implementation is Visio by Microsoft Corporation, Redmond, Wash. Other suitable graphics programs can be utilized. When a document 704 is created or an existing document is loaded into GUI 400 by the user, a ThisDocument class and ThisPage class can be initialized that are referenced to ApplicationController 706. ApplicationController 706 can be initialized by the ThisDocument class, and an instance 708 of Representation.Package class can be created that holds a reference to ApplicationController 706 during the session. ApplicationController 706 manages the interaction between the user and Package instance 708. When messages to operate on a element of the package are received by ApplicationController 706, ApplicationController 706 can create Agents.ModalDialogController instance (not shown) and indirectly a Agents.ModalDialogView instance (not shown) that are responsible for performing a specific action on the package element being modified or acted on. Each document 704 can include one or more pages 710 of shapes 712 with connection lines 714 that represent the flow among components (cells) 716 in the package. User input events such as ShapeAdded and ShapeDeleted can be forwarded to ApplicationController 706 during the user's session.

ApplicationController 706 can be placed in a PAC Agents namespace that includes presentation, abstraction and control classes. The abstraction class can include one or more classes from the functional core 306 that make up the data the agent is working on, for example, ModelerAbstractions:Shape 718. The presentation class can be a user interface form that displays abstraction data to the user and allows the user to interact with that data. The control class is responsible for managing the interaction between the abstraction and the presentation class, thereby consistently organizing the responsibilities of ApplicationController 706 into manageable pieces.

DocumentController 720 can be responsible for managing the interaction between the user interface elements that represent a workflow document and the workflow document itself (i.e. the workflow designer object model). PackageController 722 can be responsible for managing the interaction between the package (workflow) document and the user interface elements in the flow diagram that represents the workflow. StatementEditControllerBase 724 can be a base class that provides polymorphic access between PackageController 722 and ExpressionEditController 726. ExpressionEditController 726 can be responsible for editing the details of a workflow statement which is represented visually in the flow diagram as a shape or group of shapes. When editing a workflow statement in UI 400, which can be invoked by clicking a statement shape in the diagram, a modal window can be displayed that allows the user to edit the details of the workflow statement.

A number of Representation objects in functional core layer 306 can be used to create a package flow. The root node of the flow can be a package object that includes the inputs and outputs of the package, along with StatementCollection object 730, Statement object 732, and Expression object 734, and ExpressionCollection object 736 that include the actual flow of the package.

The StatementCollection object 730 can include objects of the Statement type, or any object that derives from that type, such as ResourceBindStatement 738, EUExecuteStatement 740, Declaration 742, ResourcelnvokeStatement (not shown), and ConditionalStatement (not shown). The ResourceBindStatement 738 can be used to bind to a specific instance of a specific resource at runtime. The binding allows the flow to inspect the properties of the resource as well as executing operational methods off of the resource instance.

Operational methods of a resource can be invoked using a ResourcelnvokeStatement (not shown). The inputs from the operational method can be assigned from other objects, including package inputs, outputs from other resources, and outputs from an EUExecuteStatement 740 and Declaration statements 742. EUExecuteStatement 740 can be used to execute an EU 231 (FIG. 2A). EU 231 typically has inputs and outputs that can be used to interact with other objects in the flow.

PrimitiveExpression 746 is an expression that does not involve variables. A Reference 748 can be a reference to a variable that was defined using a Declaration 742, and can be used in cases where a variable must be created to temporarily store a value computed by an expression, but which has not been declared as a variable by the user.

The properties of a resource, and inputs and outputs from EUs 231 can be used as inputs to other objects in the flow. A ForeachStatement (loop) can be used to iterate through a collection of objects, including iterating through contained resources. A ConditionalStatement can be used to drive logic based on the content of one of the outputs. For example, if the flow includes a bound resource WindowsServer, the conditional could take different actions based on whether the VersionMajor was greater than 4.

A Repository abstraction class can include objects such as RepositoryFacade 750, ResourceRepositoryFacade 752, PackageRepositoryFacade 754, and EURepositoryFacade 756 that can be queried by the Representation objects to get the needed information to populate data including the names of the available EUs 231, packages 220, 222, and resources, along with the inputs and outputs for each. Note that the interaction between the Repository abstraction class and the Representation objects can remain unchanged while the underlying mechanism for gathering the required data can be changed.

Note that other suitable classes can be utilized in package 230, in addition to, or instead of, the classes described herein.

Identifying and cataloging aggregated service resources and their dependencies allows organizations to have a flexible environment where the aggregated service resources no longer are tied to physical hardware and can be moved easily using a “drag-drop” metaphor. Once discovered and identified, defined methods can be performed on a resource.

The logic modules, processing systems, and circuitry described herein may be implemented using any suitable combination of hardware, software, and/or firmware, such as Field Programmable Gate Arrays (FPGAs), Application Specific Integrated Circuit (ASICs), or other suitable devices. The logic modules can be independently implemented or included in one of the other system components. Similarly, other components are disclosed herein as separate and discrete components. These components may, however, be combined to form larger or different software modules, logic modules, integrated circuits, or electrical assemblies, if desired.

While the present disclosure describes various embodiments, these embodiments are to be understood as illustrative and do not limit the claim scope. Many variations, modifications, additions and improvements of the described embodiments are possible. For example, those having ordinary skill in the art will readily implement the processes necessary to provide the structures and methods disclosed herein. Variations and modifications of the embodiments disclosed herein may also be made while remaining within the scope of the following claims. The functionality and combinations of functionality of the individual modules can be any appropriate functionality. In the claims, unless otherwise indicated the article “a” is to refer to “one or more than one”.

1. A system for managing information technology (IT) resources, comprising:
at least one resource definition, wherein the resource definition specifies a location and identity of a corresponding resource, and methods that can be performed on the resource;
logic instructions operable to:
store an instance of the resource that includes information from the at least one resource definition; and
generate a package based on at least one execution unit (EU), workflow associated with the EU, and the resource definition, wherein the package causes at least one of the methods to be performed on the resource.

2. The system of claim 1, further comprising:
logic instructions operable to:
create a job when the package is invoked; and
provide the job to a job controller, wherein the job controller directs the package and the EU to be loaded for execution.

3. The system of claim 1, further comprising:
logic instructions operable to:
generate the at least one resource definition, wherein the at least one resource definition further includes information regarding the author and the version of the at least one resource.

4. The system of claim 1, wherein the at least one resource definition further includes information regarding other resources that are dependent on the at least one resource.

5. The system of claim 1, wherein the at least one resource definition further includes enumeration information regarding the value of attributes of the resource.

6. The system of claim 1, wherein the at least one resource definition further includes information regarding properties of the at least one resource definition.

7. The system of claim 1, further comprising:
a resource discovery controller operable to discover the at least one resource definition, wherein one of the methods in the at least one resource definition is a discover method that can be executed by the resource discovery controller.

8. The system of claim 1, wherein:
the logic instructions operable to generate a package designer user interface including symbols representing variables, EUs, and methods associated with the resource; and
the package designer user interface allows the user to select one or more of the symbols and arrange the selected symbols in a flow diagram.

9. The system of claim 8, wherein:
the package designer user interface further allows the user to perform at least one of the following operations: set variables, specify labels for the symbols, enter conditions to specify the workflow between the selected EUs and methods, provide expressions to be evaluated, and provide linkage information between the symbols.

10. The system of claim 8, wherein:
the logic instructions operable to generate a package designer user interface include components that are configured in a presentation layer for the user interface, a functional core layer that encapsulates the flow of the package, and a dialog layer that acts as a liaison between the presentation layer and the functional core layer.

11. The system of claim 10, wherein:
the dialog layer is configured with presentation-abstraction-control (PAC) agents.

12. The system of claim 8, wherein:
the logic instructions operable to generate a package designer user interface are further operable to generate Representation objects for the flow diagram.

13. The system of claim 12, wherein:
the logic instructions operable to generate a package designer user interface include a Repository abstraction class to represent elements of the at least one resource definition that can be queried by the Representation objects.

14. The system of claim 1, wherein the at least one resource definition is an Extensible Markup Language (XML) schema.

15. The system of claim 1, further comprising:
at least one user role definition including at least one of the group of: administrator; resource administrator; resource discoverer; an EU designer; a package designer; a tester; a package approver; a job creator; and a job dispatcher.

16. The system of claim 7, further comprising:
a discovery module configured to provide information regarding the resource to the resource discovery controller.

17. The system of claim 1, wherein the logic instructions are implemented as software instructions stored on a computer-readable medium.

18. The system of claim 1, further comprising:
a processor configured to execute the logic instructions.

19. A method for managing IT resources, comprising:
defining methods and attributes of at least one of the IT resources, thereby generating a resource definition;
discovering the methods and attributes of the at least one IT resource based on the resource definition;
generating an instance of the at least one IT resource based on the resource definition;
accessing the resource definition to generate a package that specifies a method to perform on at least one of the IT resources;
compiling the package to generate an executable file;
invoking the package;
generating a job based on the invoked package; and
executing the job to execute the executable file.

20. The method of claim 19, further comprising:
determining the dependency of the at least one IT resource on the other IT resources.

21. The method of claim 19, further comprising:
determining an inheritance hierarchy of the at least one IT resource.

22. The method of claim 19, further comprising:
determining a containment hierarchy of the at least one IT resource.

23. The method of claim 19, further comprising:
including an execution unit (EU) in the package, wherein the EU includes execution logic and a document that provides information regarding the origin and purpose of the EU.

24. The method of claim 23, further comprising:
rolling back previously performed methods in the event execution of the EU fails.

25. The method of claim 19, further comprising:
scheduling the job for execution.

26. The method of claim 19, further comprising:
logging results of the job.

27. The method of claim 19, further comprising:
displaying selectable symbols representing the package and the at least one IT resource on an operator's console; and
invoking the package for the at least one IT resource when the package and the at least one IT resource are selected.

28. The method of claim 19, further comprising:
presenting symbols representing the methods defined for the at least one IT resource in a package designer user interface display; and
allowing the user to select the methods to be performed by the package by placing the symbols selected by the user in a flow diagram in the user interface display.

29. The method of claim 19, further comprising:
generating an extension to the package.

30. The method of claim 19, further comprising:
generating an extension to the resource definition.

31. An apparatus for managing an IT resource, comprising:
means for defining methods that can be performed on the IT resource;
means for discovering the methods to generate a package that specifies a selected one of the methods;
means for invoking the package;
means for executing the package; and
means for tracking execution of the package.
